(19) United States
(12) Patent Application Publication
(10) Pub. No.: US 2018/0150800 A1
(43) Pub. Date: May 31, 2018

(54) BACKGROUND CHECK PROCESSING SYSTEM

(71) Applicant: CORPORATE SECURITY SOLUTIONS, INC., LAKE MARY, FL (US)

(72) Inventors: John Glavin, Lake Mary, FL (US); James Ettore, Sorrento, FL (US)

(73) Assignee: CORPORATE SECURITY SOLUTIONS, INC., LAKE MARY, FL (US)

(21) Appl. No.: 15/825,770

(22) Filed: Nov. 29, 2017

Related U.S. Application Data
(60) Provisional application No. 62/427,258, filed on Nov. 29, 2016.

(51) Int. Cl. G06Q 10/10; G06F 17/30; G06Q 20/40; G06Q 20/32; G06Q 20/14

(52) U.S. Cl. CPC G06Q 10/105; G06F 17/30864; G06Q 50/265; G06Q 20/3224; G06Q 20/14; G06Q 20/4014

(57) ABSTRACT

A system for performing a background check having a mobile computing device that can capture an optical image of a government issued identification, extract personal identifying information from the image of the government issued identification, and use the information to request a background check from a remote server. The remote server uses the information extracted from the government issued identification to select the appropriate databases for querying, prepares a report reflecting the results of the background check, and transmits the background check report to the mobile computing device.

### CROSS-REFERENCE TO RELATED APPLICATIONS

The present application claims priority to U.S. App. No. 62/427,258 filed on Nov. 29, 2016.

### BACKGROUND OF THE INVENTION

### 1. Field of the Invention

The present application relates to the performance of background checks and, more specifically, to a system that can automatically obtain the required permissions and perform background check processing.

### 2. Description of the Related Art

Many employers choose to perform background checks on prospective employees. Employment Background checks are governed by various federal laws, including the Fair Credit Reporting Act (FCRA). As a result, performing a background check requires that an employer provide adequate notice to the prospective employee of its intent to perform a background check, obtain the appropriate authorizations, and comply with all applicable regulations and laws. Conventional approaches to background checks thus require numerous manual steps, filling out of paperwork, and compliance review before beginning the process of performing a background check. Once the authorization process is complete, an employer must then contact an outside agency that actually performs the background check and reports back on its finding. Accordingly, there is a need in the art for a system that can streamline the background check process from the initial authorization to the final reporting of background information while ensuring compliance with the applicable rules and regulations.

### BRIEF SUMMARY OF THE INVENTION

The present invention provides a seamless and automated system for collecting the necessary information for a background check, provides the appropriate disclosures, collecting the appropriate authorizations, and requests and receives a background check based on the collected information. The present invention includes a mobile computing device having an imager that can take picture of a government issued identification or read the barcode imprinted on the identification. The mobile computing device is programmed to capture an image of a government issued identification, to extract any information encoded in the government issued identification, to transmit the extracted information to a remote server, and to receive a report reflecting background check information from the remote server. A remote server is positioned remotely from the mobile computing device and programmed to receive any information extracted from the government issued identification by the mobile computing device and to perform a background check using the information extracted from the government issued identification. The mobile computing device is further programmed to collect payment information prior to receiving the report. The mobile computing device may also be programmed to track any reports received from the remote server. The mobile computing device may further be programmed to allow editing of the extracted information prior to transmitting the extracted information to the remote server. The mobile computing device can also be programmed to present disclosure information and to obtain a signature reflecting acceptance of the disclosure information.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a system for performing background checks according to the present invention;

FIG. 2 is a flowchart of a background check process according to the present invention;

FIG. 3 is a flowchart of a business to business background check process according to the present invention; and

FIG. 4 is a schematic of an accounting system for a background check process according to the present invention.

### DETAILED DESCRIPTION OF THE INVENTION

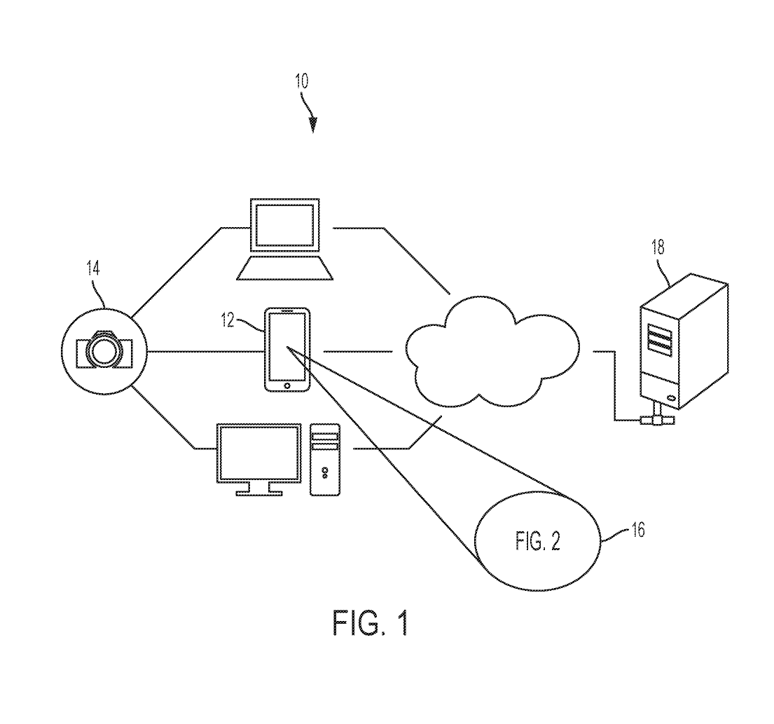

Referring to the figures, wherein like numerals refer to like parts throughout, there is seen in FIG. 1 a system 10 for automatically obtaining authorization for and executing a background check. System 10 requires a computing device 12, such as smartphone or tablet, having an imager 14 that can capture a digital image of the identification of an individual whose background is to be checked. Mobile computing devices are generally preferred, but desktop computers may also be used interchangeably. As explained below, computing device 12 hosts an application 16 that is programmed to collect the necessary information and authorizations for a background check, to communicate with a server 18, such as that operated by a background check provider that performs background checks. Server 18 is thus a hardware unit having programmable elements that are programmed with software to communicate with application 16 over existing communication channels, such as the internet. Application 16 also arranges for payment for background check services, such as via pre-established company billing codes or credit card information, and accepts the results of a background check from server 18. Application 16 may be an Android or iOS application to be run on Internet-connected device 12.

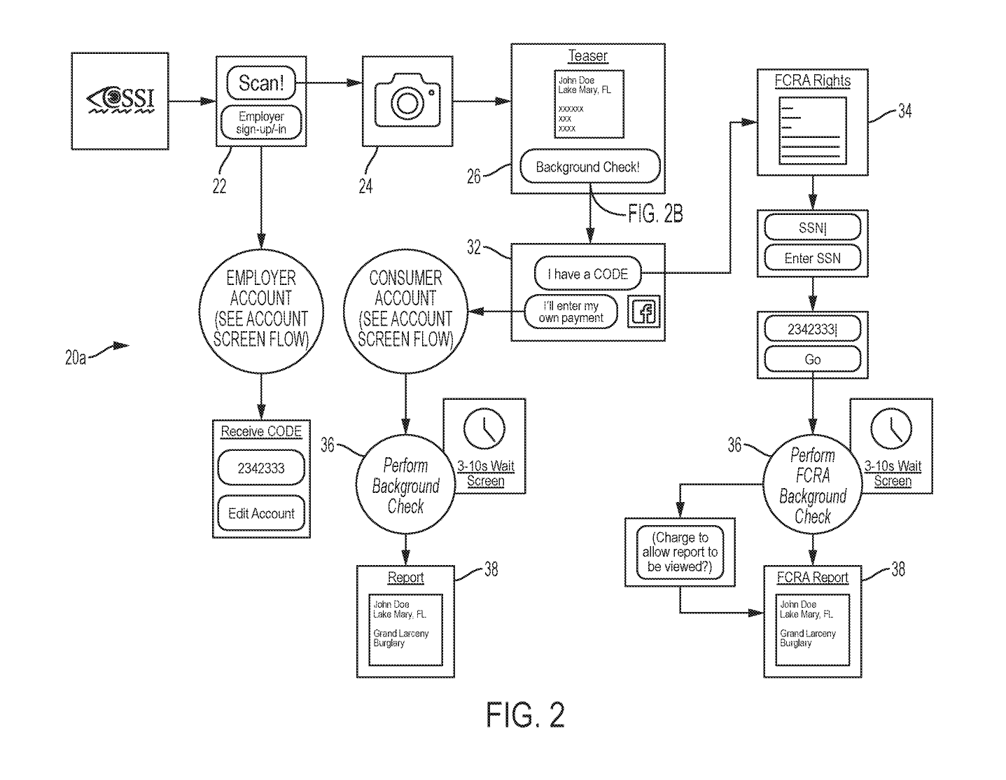

Referring to FIG. 2, application 16 may be programmed to implement a background check process 20a that requires an initial login 22, such as by an employer that desires a background check to be performed on a prospective employee. Once application 16 has been enabled with an appropriate login 22, application 16 may be used to trigger the capturing of an image 24 of the government issued identification of the prospective employee. For example, the user may be provided with a prompt to place the government issued identification in front of imager 14. Using conventional decoding technologies, application 16 extracts identifying information from the government issued identification 26 so that the extracted information may be used for the background check. For example, a PDF417 barcode is a stacked linear barcode symbol format used in a variety of applications, primarily transport, identification cards, and inventory management. PDF417 barcodes are typically included on a government issued identification card may be decoded to obtain the personal information of the prospective employee that is encoded therein. The PDF417 barcode includes name, address and date of birth are encoded directly within the data on the barcode and thus can be extracted by decoding the barcode in the image captured by device 12 using conventional barcode decoding algorithms. Alternatively, application 16 may use optical character recognition to extract the information from the image captured by device 12. In either case, the name of the prospective employee and the residential address and/or issuer of the government identification may be determined. The particular issuer of the government identification, such as the particular state department of motor vehicles in the case of a driver's license, is retained for use in properly directing the background check process.

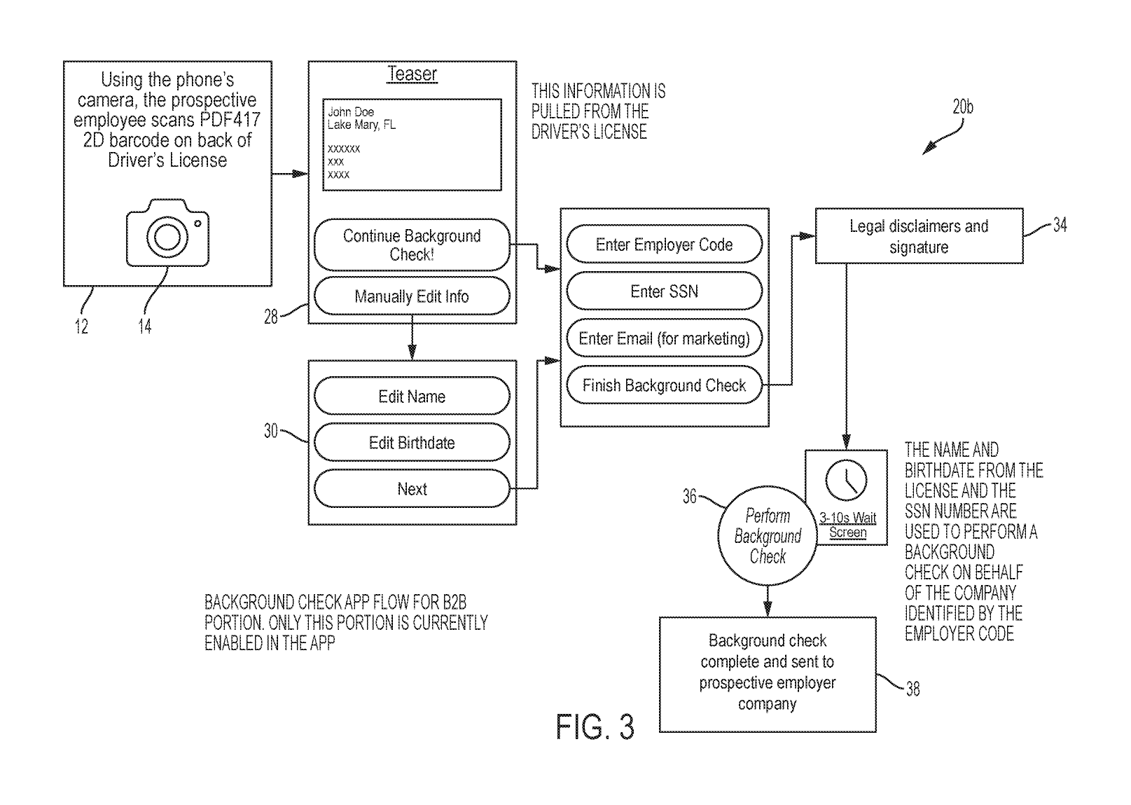

Referring to FIG. 3, a modified background check process 20b may be used for corporate users that order numerous background checks. In process 20b, application 16 may display the decoded information for acceptance or editing by the user 28. Application 16 may also provide an input screen 30 to collect any additional information, such as a Social Security Number (SSN), that might be required in addition to the government identification information to perform a comprehensive background check. Application 16 may additionally allow the user to enter a predetermined billing code 32 or provide payment information for the cost of the background check. Once the payment arrangements have been confirmed, the appropriate disclosure information may be presented on computing device 12 for display to the prospective employee and then collection of a prospective employee signature 34 to acknowledge the disclosure information and give consent for the background check. For example, the Fair Credit and Reporting Act (FCRA) require certain written disclosures to be made and accepted by prospective employee with a signature prior to performing a background check. Additionally, corporate human resource forms and authorizations may be presented to the prospective employee or new employee to improve the efficiency of the prospective employee evaluation process or new employee enrollment process. Electronic signatures for compliance with the FCRA and any other governmental or corporate requirements may be captured used conventional touchscreen capabilities of device 12 running application 16 or using an external touchpad interfaced with device 12.

Once application 16 has collected the necessary information and confirmed payment, application 16 sends a background check request 36 to a remote server 18. Background check request 36 may be registered with remote server 18 using email address of user of device 12 or other individually identifying information to track devices 12 used in system 10. Remote server 18 is programmed to use the information collected by application 16 to execute a background check. For example, server 18 is programmed to use the residence or issuer of the government issued identification to select the appropriate databases to query for background information about the prospective employee. Alternatively, server 18 may use geographical location information about the location of application 16, such as global positioning system (GPS) coordinates, in addition to any residential information obtained through government identification scanning, to select the appropriate databases to query for the optimal background check. For example, server 18 may be programmed to search databases such as those providing national background checks, motor vehicle reports, county background checks, and federal background checks as well as those providing financial checks and social media reports. The provision of geographic information obtained automatically by application 16 thus improves the speed of processing of the background check and the accuracy and relevancy of the results. The queries may be conducted using the personal information collected by application 16, the location of the prospective employee at the time of scanning, etc. and only on the relevant databases. As an example, server 18 may comprise a dedicated cloud-based site that is programmed to receive background check request 36 from device 12 and perform the requisite check. The results of the background check performed by server 18 are then packaged according to a default layout or any format requested by the employer and delivered as a completed report 38 to application 16 for review by a representative of employer.

Receipt of report by application 16 may be logged for accounting purposes and charging of agreed upon fees for the background check by any third party hosting server 18. It should be recognized by those of skill in the art that application 16 may be provided by the same entity as server 18 and various payment schemes agreed upon for the use of the background check services, such as a flat fee for each report or monthly access fees.

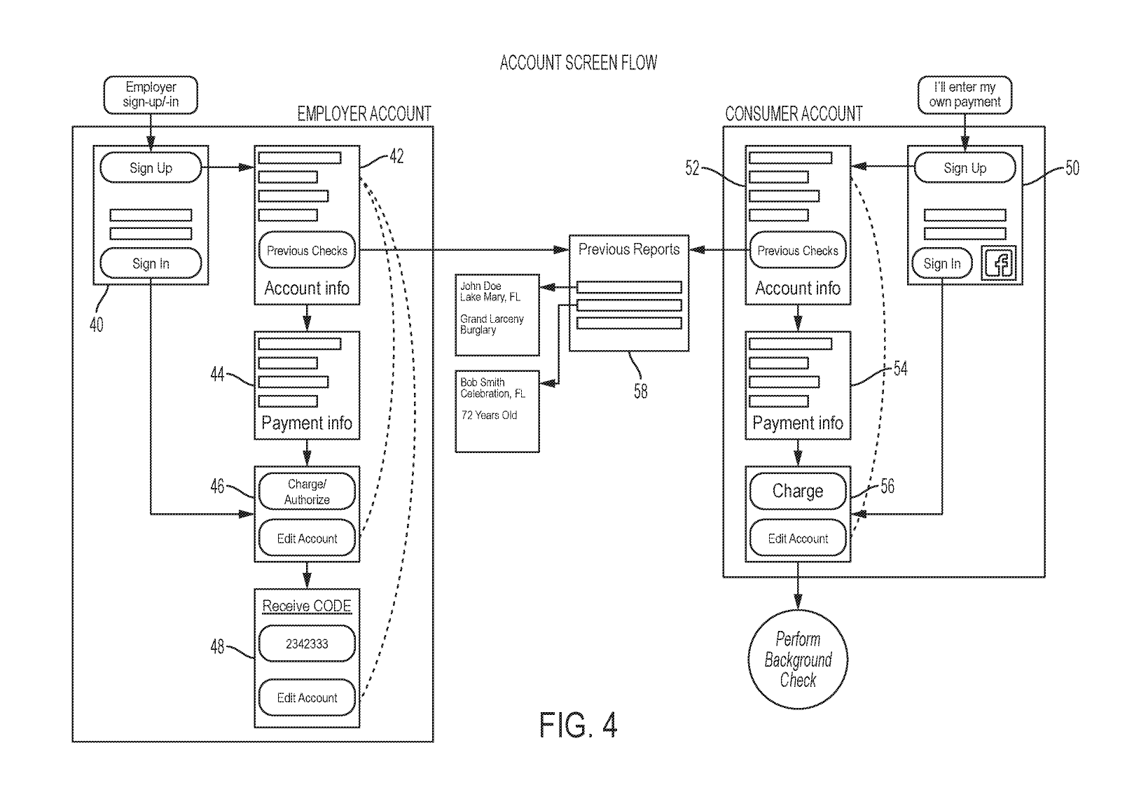

Referring to FIG. 4, system 10 may be configured for use by employers or individual consumers. For example, an employer may establish a new login 40 and formation of a corporation account 42 along with entry of recurrent payment information 44. When whenever a background check is to be performed, system 10 can then present an authorization to charge screen 46 and provide a security code 48. Similarly, an individual consumer may be allowed to sign up 50, establish an account 52, and enter one-time or recurrent payment information 54 for paying for a particular background check request 56. In either case, application 16 tracks prior usage and delivered reports 58 for accounting and other record keeping purposes.

As described above, the present invention may be a system, a method, and/or a computer program associated therewith and is described herein with reference to flowcharts and block diagrams of methods and systems. The flowchart and block diagrams illustrate the architecture, functionality, and operation of possible implementations of systems, methods, and computer programs of the present invention. It should be understood that each block of the flowcharts and block diagrams can be implemented by computer readable program instructions in software, firmware, or dedicated analog or digital circuits. These computer readable program instructions may be implemented on the processor of a general purpose computer, a special purpose computer, or other programmable data processing apparatus to produce a machine that implements a part or all of any of the blocks in the flowcharts and block diagrams. Each block in the flowchart or block diagrams may represent a module, segment, or portion of instructions, which comprises one or more executable instructions for implementing the specified logical functions. It should also be noted that each block of the block diagrams and flowchart illustrations, or combinations of blocks in the block diagrams and flowcharts, can be implemented by special purpose hardware-based systems that perform the specified functions or acts or carry out combinations of special purpose hardware and computer instructions.

What is claimed is:

1. A system for checking the background of a subject, comprising:
a mobile computing device having an imager; and
wherein the mobile computing device is programmed to capture an image of a government issued identification, to extract any information encoded in the government issued identification, to transmit the extracted information to a remote server, and to receive a report reflecting background check information from the remote server.

2. The system of claim 1, further comprising a remote server positioned remotely from the mobile computing device, wherein the remote server is programmed to receive any information extracted from the government issued identification by the mobile computing device and to perform a background check using the information extracted from the government issued identification.

3. The system of claim 2, wherein the mobile computing device is further programmed to collect payment information prior to receiving the report.

4. The system of claim 3, wherein the payment information is a predetermined billing code.

5. The system of claim 3, wherein the payment information is electronic payment information.

6. The system of claim 3, wherein the mobile computing device is further programmed to track any reports received from the remote server.

7. The system of claim 6, wherein the mobile computing device is further programmed to allow editing of the extracted information prior to transmitting the extracted information to the remote server.

8. The system of claim 7, wherein the mobile computing device is further programmed to present disclosure information and to obtain a signature reflecting acceptance of the disclosure information.

9. The system of claim 8, wherein the mobile computing device is programmed to transmit the extracted information to the remote server only if the payment information has been collected.

10. The system of claim 9, wherein the mobile computing device includes geographic location information and the mobile computing device is programmed to transmit the geographic location information along with the extracted information to the remote server so that the geographic location information may be used to expedite processing of the report reflecting background check information.

11. A method of performing a background check, comprising the steps of:
providing a user with mobile computing device having an imager;
using the imager of the mobile computing device to capture an image of a government issued identification of an individual to be subject to a background check;
using an application programmed into the mobile computing device to extract information encoded in the government issued identification and captured in the image;
transmitting the extracted information to a remote server that is programmed to perform a background check using the extracted information;
preparing a report reflecting the background check; and
transmitting the report to the mobile computing device for display to the user.

12. The method of claim 11, further comprising the step of transmitting the geographic location of the mobile computing device along with the extracted information to the remote server.

13. The method of claim 12, further comprising the step of collecting payment information prior to receiving the report.

14. The method of claim 13, wherein the payment information comprises a predetermined billing code.

15. The method of claim 14, wherein the payment information comprises electronic payment information.

16. The method of claim 12, further comprising the step of tracking any reports received from the remote server.

17. The method of claim 16, further comprising the step of displaying the extracted information prior to transmitting the extracted information to the remote server.

18. The method of claim 17, further comprising the step of allowing editing of the displayed extracted information prior to transmitting the extracted information to the remote server.

19. The method of claim 18, wherein the step of transmitting the extracted information to the remote server only occurs if payment information has been collected.

20. The method of claim 19, further comprising the steps of presenting disclosure information and obtaining a signature reflecting acceptance of the disclosure information prior to transmitting the extracted information to the remote server.
